(19) United States
(12) Patent Application Publication
(10) Pub. No.: US 2015/0149332 A1
(43) Pub. Date: May 28, 2015

(54) SYSTEMS AND METHODS FOR MONITORING CARDHOLDER RETURN ACTIVITY

(71) Applicant: MasterCard International Incorporated, Purchase, NY (US)

(72) Inventors: Mary E. Lesbirel, Holmdel, NJ (US); Debashis Ghosh, Charlotte, NC (US)

(73) Assignee: MasterCard International Incorporated, Purchase, NY (US)

(21) Appl. No.: 14/090,854

(22) Filed: Nov. 26, 2013

(51) Int. Cl. G06Q 40/00

(52) U.S. Cl. CPC G06Q 40/12
USPC 705/30

(57) ABSTRACT

A computer-implemented method for monitoring cardholder return activity associated with cardholder transactions is implemented by a monitoring computer system coupled to a memory. The method includes receiving a set of first transaction data associated with a first transaction initiated by a cardholder at a merchant, determining that the first transaction is a first return transaction including a set of first return transaction data, retrieving a return record associated with the cardholder, wherein the return record is stored within the memory, and updating the return record associated with the cardholder with the set of first return transaction data.

### BACKGROUND OF THE DISCLOSURE

The field of the disclosure relates generally to products returned to a merchant by a cardholder after purchase, and more particularly, to systems and methods for monitoring product return activity of a cardholder.

In at least some cardholder-initiated financial transactions, the cardholder (e.g., an entity using a payment card such as a credit card, a debit card, or a prepaid card) may seek to return goods or services to a merchant after such goods or services were initially purchased from the merchant. When a return occurs, the merchant may experience financial, logistic, or opportunity costs related to the return of the goods or services. For example, fees may be associated with the refurbishment and restocking of goods. In other examples, the goods may no longer be sellable and may need to be returned to a manufacturer or wholesaler. In the example of services, returned goods may have not been performed and a full refund may be provided. A merchant may, in this example, lose the revenue associated with the return and additionally lose the opportunity to sell the service because the time to deliver the service has passed. In further examples, the merchant may have ordered additional inventory between the time of the initial purchase and the return. The merchant may therefore have excess inventory in stock that may be inappropriate to the merchandising projections of the merchant. In these examples, the merchant may experience a financial loss on the transaction due to the return. Accordingly, a merchant may wish to monitor the activity related to returns to understand the financial impact of returns.

Some cardholders may additionally be more likely to return at least some particular types of goods or services (collectively referred to herein as “products”). In such cases, merchants may find it valuable to have information regarding the return of products including information on cardholders who are more likely to return purchased products. Cardholders who are more likely to return goods and services may be those who have returned products in the past to the merchant or other merchants. Alternatively, cardholders who are more likely to return products may be those who have returned similar products to similar merchants.

### BRIEF DESCRIPTION OF THE DISCLOSURE

In one aspect, a computer-implemented method for monitoring cardholder return activity associated with cardholder transactions is provided. The method is implemented by a monitoring computer system coupled to a memory. The method includes receiving a set of first transaction data associated with a first transaction initiated by a cardholder at a merchant, determining that the first transaction is a first return transaction including a set of first return transaction data, retrieving a return record associated with the cardholder wherein the return record is stored within the memory, and updating the return record associated with the cardholder with the set of first return transaction data.

In another aspect, a monitoring computer system for monitoring cardholder return activity associated with cardholder transactions is provided. The monitoring computer system includes a processor and a memory coupled to the processor. The monitoring computer system is configured to receive a set of first transaction data associated with a first transaction initiated by a cardholder at a merchant, determine that the first transaction is a first return transaction including a set of first return transaction data, retrieve a return record associated with the cardholder, and update the return record associated with the cardholder with the set of first return transaction data.

In a further aspect, computer-readable storage media for monitoring cardholder return activity associated with cardholder transactions is provided. The computer-readable storage media has computer-executable instructions embodied thereon. When executed by at least one processor, the computer-executable instructions cause the processor to receive a set of first transaction data associated with a first transaction initiated by a cardholder at a merchant, determine that the first transaction is a first return transaction including a set of first return transaction data, retrieve a return record associated with the cardholder, and update the return record associated with the cardholder with the set of first return transaction data.

### BRIEF DESCRIPTION OF THE DRAWINGS

The figures listed below show example embodiments of the methods and systems described herein.

FIGS. 1-8 show example embodiments of the methods and systems described herein.

FIG. 1 is a schematic diagram illustrating an example multi-party payment card industry system for enabling ordinary payment-by-card transactions, including return transactions, in which merchants and card issuers do not necessarily have a one-to-one relationship.

FIG. 2 is a simplified block diagram of an example monitoring computer system used to monitor cardholder return activity associated with cardholder transactions including a plurality of computer devices in accordance with one example embodiment of the present disclosure.

FIG. 3 is an expanded block diagram of an example embodiment of server architecture of the monitoring computer system used to monitor cardholder return activity associated with cardholder transactions including the plurality of computer devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a data flow diagram of the monitoring computer system shown in FIG. 2.

FIG. 7 is a simplified diagram of an example method of monitoring cardholder return activity associated with cardholder transactions using the monitoring computer system of FIG. 2.

FIG. 8 is a diagram of components of one or more example computing devices that may be used in the environment shown in FIG. 6.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

This subject matter described herein relates generally to monitoring cardholder return activity (i.e., the return of purchase goods and/or services) associated with cardholder transactions. Transaction data associated with cardholder-initiated financial transactions is received by a return monitoring computer system (“monitoring computer system”). Specifically, the methods and systems described herein include receiving a set of first transaction data associated with a first transaction initiated by a cardholder at a merchant, determining that the first transaction is a first return transaction including a set of first return transaction data, retrieving a return record associated with the cardholder wherein the return record is stored within the memory, and updating the return record associated with the cardholder with the set of first return transaction data.

In at least some cardholder-initiated financial transactions, the cardholder (e.g., an entity using a payment card such as a credit card, a debit card, or a prepaid card) may seek to return goods or services (collectively referred to herein as “products”) to a merchant after such products were initially purchased from the merchant. In at least some examples, the merchant may experience financial, logistic, or opportunity costs related to the return of the products. For example, fees may be associated with the refurbishment and restocking of products. In other examples, the products may no longer be sellable and may need to be returned to a manufacturer or wholesaler. In further examples, the merchant may have ordered additional inventory between the time of the initial purchase and the return. The merchant may therefore have excess inventory in stock that may be inappropriate to the merchandising projections of the merchant. In these examples, the merchant may experience a financial loss on the transaction due to the return. Accordingly, a merchant may wish to monitor the activity related to returns to understand the financial impact of returns.

The systems and methods described herein are configured to monitor cardholder return activity associated with cardholder transactions. More specifically, a monitoring computer system receives a set of first transaction data associated with a cardholder-initiated first transaction at a merchant. For example, the cardholder may initiate a transaction with a merchant using a payment card such as a credit card, a debit card, or a prepaid card. In at least some cases, such transactions are return transactions that are initiated subsequent to an initial purchase of products. In other words, the cardholder initiates a return transaction where the cardholder returns products and obtains a partial or complete refund of a purchase price for the initial purchase of the products. The monitoring computer system may be in networked communication with a payment network, a merchant computing device, and an issuer computing device. The monitoring computer system may receive the set of first transaction data from at least one of the payment network, the merchant computing device, and the issuer computing device.

The monitoring computer system determines that the first transaction is a first return transaction including a set of first return transaction data. The monitoring computer system determines that the first transaction is a first return transaction by processing the set of first transaction data to identify the presence of a return indicator. As described further below, the return indicator may include, for example and without limitation, a negative transaction amount reflecting a payment by the merchant to a cardholder, a reference to a previous financial transaction between the cardholder and the merchant, and an explicit indicator identifying the fact that the first transaction is a return transaction. Such an explicit indicator may include, for example, a flag indicating that a transaction is a return transaction. In one example, the set of first transaction data may include a record for “Transaction Type” with a possible value of “Return”. Accordingly, when the monitoring computer system processes the set of first transaction data and identifies a value of “Return”, the monitoring computer system may accordingly identify the value as an explicit indicator that serves as a return indicator. In another example, the set of first transaction data may include a record for “Return Transaction” with possible values of, “Y” and “N”. Similarly, when the monitoring computer system processes the set of first transaction data and identifies a value of “Y”, the monitoring computer system may accordingly identify the value as an explicit indicator that serves as a return indicator.

The monitoring computer system retrieves a return record associated with the cardholder. The monitoring computer system retrieves the return record by identifying at least one cardholder identifier associated with the set of first return transaction data and retrieving a return record associated with the at least one cardholder identifier. The cardholder identifier may be any identifier that can connect data stored in the set of first transaction data to the return record. Accordingly, the cardholder identifier may include, without limitation, an account number associated with the cardholder, location information associated with the cardholder, and a name associated with the cardholder. The return record is retrieved from at least one of the memory device associated with the monitoring computer system, a database in communication with the monitoring computer system, networked storage in communication with the monitoring computer system, or an external storage device in communication with the monitoring computer system.

The return record may additionally include a historical record including a historical record of related returns. The historical record of related returns may include a set of second return transaction data wherein the set of second return transaction data is substantially similar to the set of first return transaction data. The set of second return transaction data may be determined to be substantially similar to the set of first return transaction data based on a plurality of characteristics including, without limitation, products returned, categories associated with products returned, locations and times of product returns, time differences between initial purchase of products and returns of products, value of products, and brand of products. For example, the set of second return transaction data may relate to products that are substantially similar to the products returned in the set of first transaction data. Alternately, the set of second return transaction data may relate to products that are different from the products returned in the set of first transaction data. In some examples, all return activity for all cardholders is included in the historical record. The set of second return transaction data may be collected from a plurality of merchant computing devices associated with a plurality of merchants. Accordingly, the set of second return transaction data may include records of related returns that are substantially similar in nature to the returns included in the set of first return transaction data but associated with different merchants. In such examples, the set of second return transaction data may be determined to be substantially similar to the set of first return transaction data based on additional characteristics including, without limitation, the location of the merchants, and the categories of the merchants.

The monitoring computer system also determines if the retrieved return record includes at least one set of second return transaction data associated with at least one second return transaction and transmits the return record to a merchant computing device. In other words, the monitoring computer system determines whether the return record indicates that the cardholder has a previous record of a similar return and, if so determined, transmits the return record to the merchant computing device. The monitoring computer system further processes the at least one set of second return transaction data to generate a cardholder risk assessment and transmits the cardholder risk assessment to the merchant computing device. The cardholder risk assessment may include a numerical score, a qualitative rating, or any other indication that a merchant may review to assess risks related to the return activity of the cardholder.

The monitoring computer system further updates the return record associated with the cardholder with the set of first return transaction data. Accordingly, the return record is updated to include return data associated with the cardholder-initiated return transaction.

The monitoring computer system additionally receives a request for a return dashboard associated with a time period. The request for a return dashboard is received from a merchant computing device. The monitoring computing system retrieves all return records associated with all cardholders associated with the merchant. The monitoring computing system identifies return records associated with the time period from all return records and generates the return dashboard associated with the time period based on the return records associated with the time period. The monitoring computer system transmits the return dashboard to the computing device. The return dashboard accordingly represents a report on all return records for cardholders associated with the requesting merchant over the requested time period.

Described in detail herein are example embodiments of systems and methods for monitoring cardholder return activity associated with cardholder transactions. The systems and methods facilitate, for example, receiving a set of first transaction data associated with a first transaction initiated by a cardholder at a merchant at the monitoring computer system, determining that the first transaction is a first return transaction including a set of first return transaction data, retrieving a return record associated with the cardholder wherein the return record is stored within the memory, and updating the return record associated with the cardholder with the set of first return transaction data.

A technical effect of the systems and methods described herein include at least one of (a) improving return processing decisions by merchants; (b) facilitating cost reduction by merchants through improved decision-making regarding return approvals; (c) reducing the financial risk associated with improper return transactions; and (d) providing analytics of cardholder returns for merchants.

More specifically, the technical effects can be achieved by performing at least one of the following steps: (a) receiving, at the monitoring computer system, a set of first transaction data associated with a first transaction initiated by a cardholder at a merchant; (b) determining that the first transaction is a first return transaction including a set of first return transaction data; (c) retrieving a return record associated with the cardholder, the return record stored within the memory; (d) updating the return record associated with the cardholder with the set of first return transaction data; (e) transmitting the return record to a merchant computing device upon determining that the return record includes at least one set of second return transaction data associated with at least one second return transaction; (f) processing the at least one set of second return transaction data to generate a cardholder risk assessment and transmitting the cardholder risk assessment to the merchant computing device; (g) processing the set of first transaction data to identify the presence of a return indicator; (h) identifying at least one cardholder identifier associated with the set of first return transaction data; (i) retrieving a return record associated with the at least one cardholder identifier from at least one of the memory, a database in communication with the monitoring computer system, and an external system in communication with the monitoring computer system; (j) retrieving a return record associated with the cardholder wherein the return record includes a historical record of related returns, the historical record of related returns including second return transaction data substantially similar to first return transaction data; (k) retrieving second transaction data collected from a plurality of merchant computing devices; (l) receiving return data at the monitoring computer system from the payment network; and (m) receiving, from a merchant computing device, a request for a return dashboard associated with a time period, retrieving all return records associated with all cardholders associated with the merchant, identifying, from all return records, return records associated with the time period, generating, based on return records associated with the time period, the return dashboard associated with the time period, and transmitting the return dashboard to the merchant computing device.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the monitoring of return cardholder return activity.

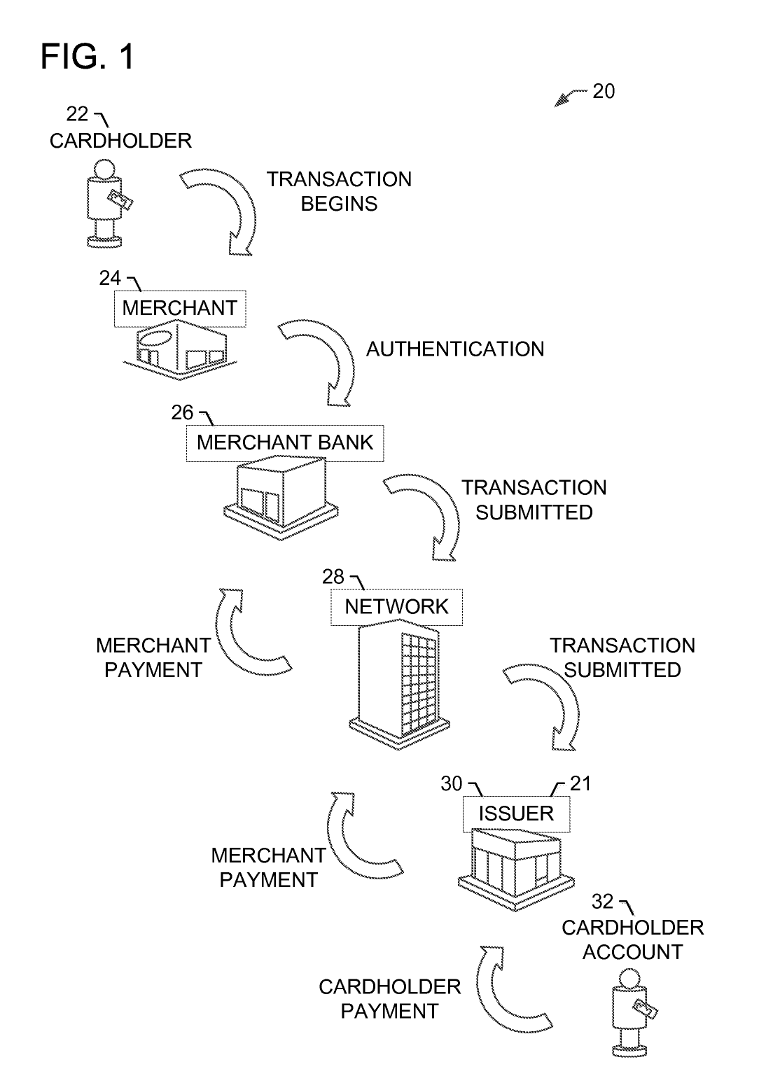

FIG. 1 is a schematic diagram illustrating an example multi-party transaction card industry system 20 for enabling ordinary payment-by-card transactions, including return transactions, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

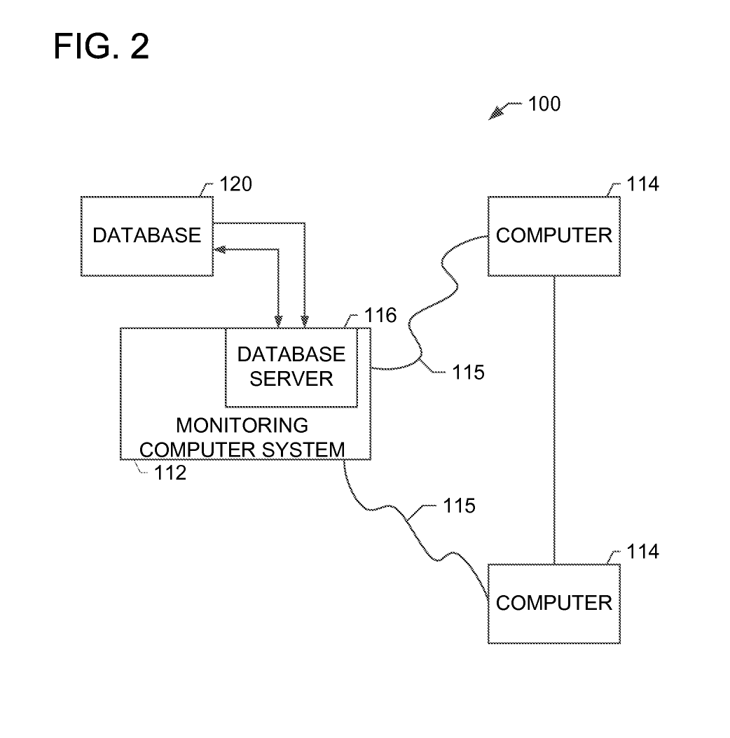

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, such additional data may also include data related to the return of products. In the example embodiment, when cardholder 22 makes a return transaction, a set of first return transaction data is received and transferred among the parties to the transaction. When interchange network 28 receives the set of first return transaction data, interchange network 28 routes the set of first return transaction data to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, a monitoring computer system may be used to determine return activity associated with a cardholder, a plurality of cardholders, and to make determinations regarding the risk associated with a cardholder return. Although the systems described herein are not intended to be limited to facilitate such applications, the systems are described as such for exemplary purposes.

FIG. 2 is a simplified block diagram of an example computer system 100 used to monitor cardholder return activity associated with cardholder transactions including a plurality of computer devices connected in communication in accordance with the present disclosure. In the example embodiment, system 100 is used for receiving a set of first transaction data associated with a first transaction, determining that the first transaction is a first return transaction including a set of first return transaction data, retrieving a return record associated with the cardholder, and updating the return record associated with the cardholder with the set of first return transaction data, as described herein. In other embodiments, the applications may reside on other computing devices (not shown) communicatively coupled to system 100, and may monitor cardholder return activity using system 100.

More specifically, in the example embodiment, system 100 includes a monitoring computer system 112, and a plurality of client sub-systems, also referred to as client systems 114, connected to monitoring computer system 112. In one embodiment, client systems 114 are computers including a web browser, such that monitoring computer system 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on monitoring computer system 112 and can be accessed by potential users at one of client systems 114 by logging onto monitoring computer system 112 through one of client systems 114. In an alternative embodiment, database 120 is stored remotely from monitoring computer system 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with acquirer bank 26 (shown in FIG. 1) while another one of client systems 114 may be associated with issuer bank 30 (shown in FIG. 1). Monitoring computer system 112 may be associated with interchange network 28. In the example embodiment, monitoring computer system 112 is associated with a network interchange, such as interchange network 28, and may be referred to as an interchange computer system. Monitoring computer system 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

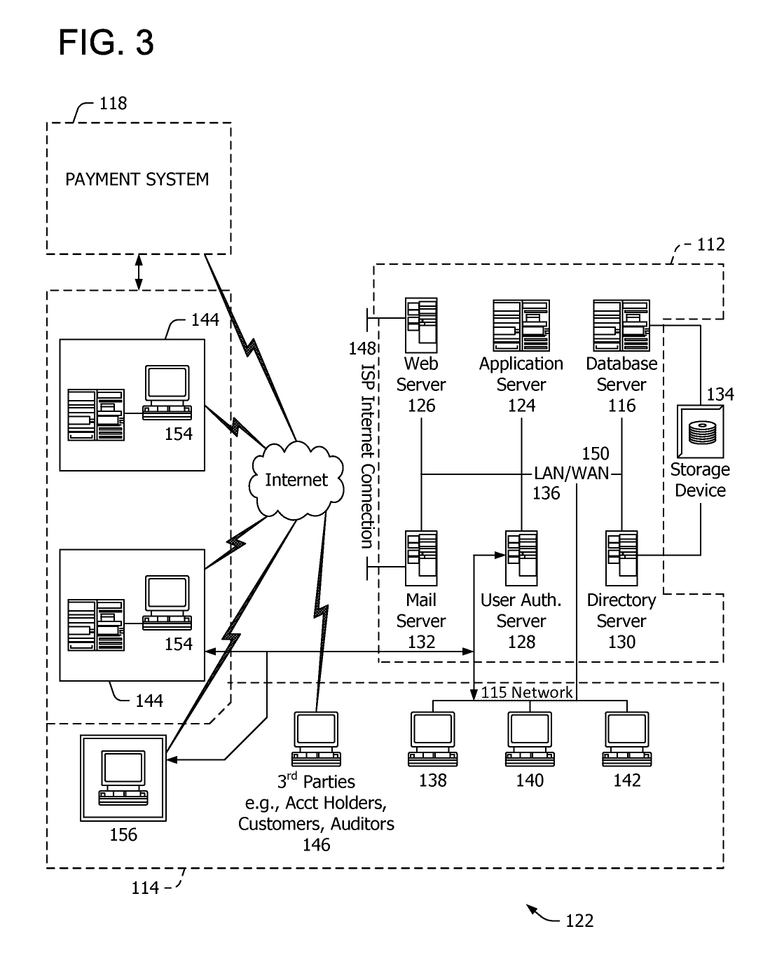

FIG. 3 is an expanded block diagram of an example embodiment of a computer server system architecture of a processing system 122 used to monitor cardholder return activity associated with cardholder transactions including other computer devices in accordance with one embodiment of the present disclosure. Components in system 122, identical to components of system 100 (shown in FIG. 2), are identified in FIG. 3 using the same reference numerals as used in FIG. 2. System 122 includes monitoring computer system 112, client systems 114, and payment systems 118. Monitoring computer system 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Monitoring computer system 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Monitoring computer system 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with monitoring computer system 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with monitoring computer system 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

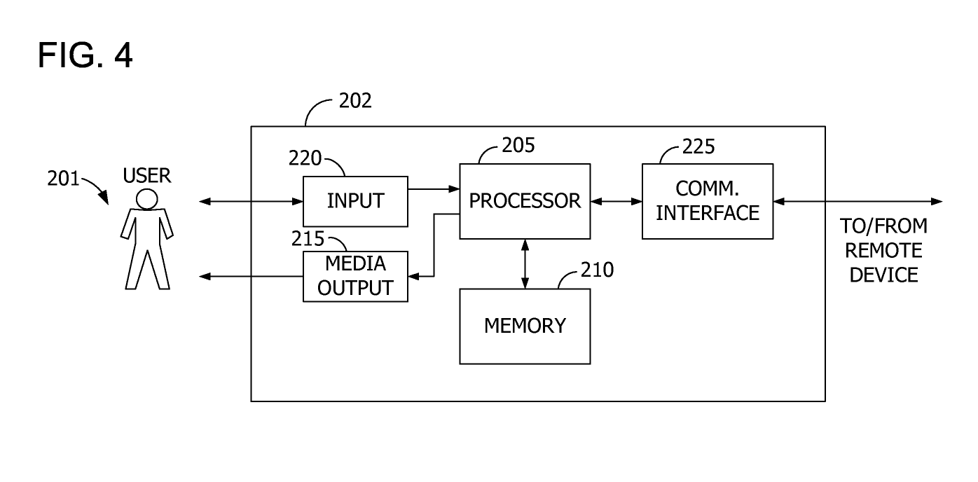

FIG. 4 illustrates an example configuration of a user system 202 operated by a user 201, such as cardholder 22 (shown in FIG. 1). User system 202 may include, but is not limited to, client systems 114, 138, 140, and 142, payment systems 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as monitoring computer system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from monitoring computer system 112. A client application allows user 201 to interact with a server application from monitoring computer system 112.

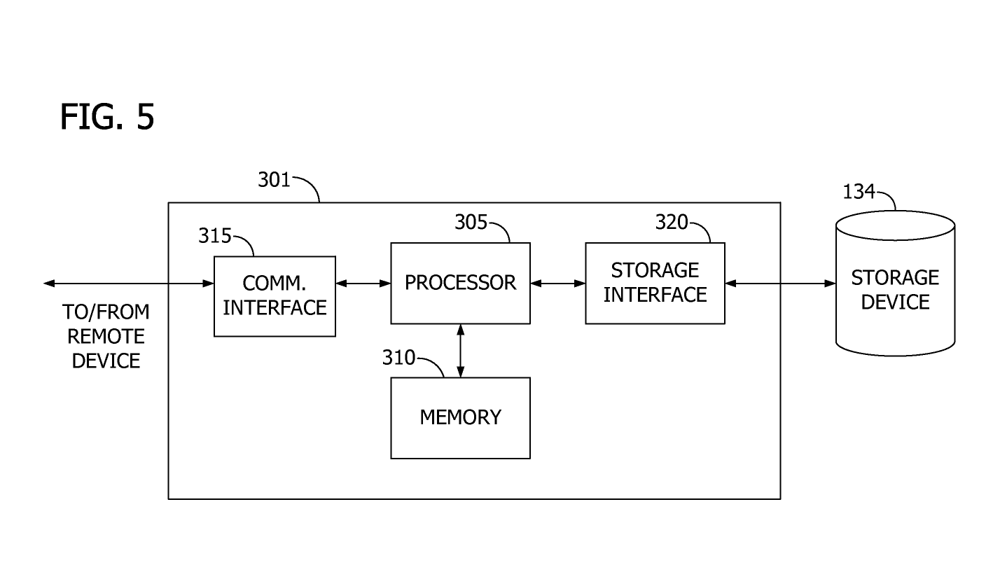

FIG. 5 illustrates an example configuration of a server system 301 such as monitoring computer system 112 (shown in FIGS. 2 and 3). Server system 301 may include, but is not limited to, database server 116, transaction server 124, web server 126, user authentication server 128, directory server 130, and mail server 132. In the example embodiment, server system 301 monitors cardholder return activity, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

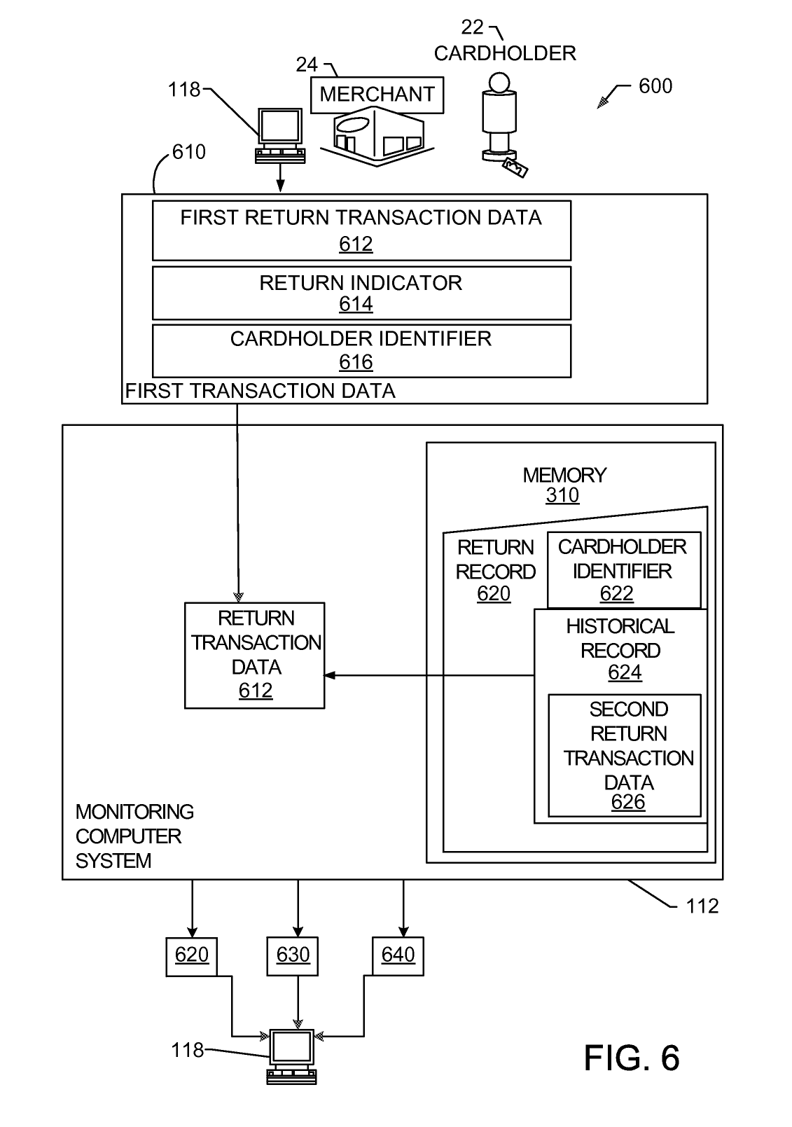

FIG. 6 is a data flow diagram of monitoring computer system 112. Monitoring computer system 112 receives a set of first transaction data 610 associated with a first transaction initiated by cardholder 22 at merchant 24. For example, cardholder 22 may initiate a transaction with merchant 24 using a payment card such as a credit card, a debit card, or a prepaid card. In at least some cases, such transactions are return transactions that are initiated subsequent to an initial purchase of products. In other words, cardholder 22 initiates a return transaction where cardholder 22 returns products and obtains a partial or complete refund of a purchase price for the initial purchase of the products. Monitoring computer system 112 is in networked communication with payment system 118. Payment systems 118 include computer systems associated with merchant bank 26, interchange network 28, issuer bank 30 (all shown in FIG. 1), and interchange network 28. In the example embodiment, payment system 118 is merchant bank computer 26 that receives data related to a return transaction initiated by cardholder 22. Monitoring computer system 112 receives set of first transaction data 610 from payment system 118, which is merchant bank computer 26 in the example embodiment.

Monitoring computer system 112 determines that the transaction initiated by cardholder 22 is a first return transaction including set of first return transaction data 612. Monitoring computer system 112 determines that the first transaction is a first return transaction by processing set of first transaction data 610 to identify the presence of return indicator 614. Return indicator 614 may include, for example and without limitation, a negative transaction amount reflecting a payment by the merchant to a cardholder, a reference to a previous financial transaction between the cardholder and the merchant, and an explicit indicator identifying the fact that the first transaction is a return transaction. For example, data contained in set of first transaction data 610 may include as follows (Table 1):

TABLE 1

| Transaction | Cardholder | Transaction | Merchant | |
|---|---|---|---|---|
| Identifier | Identifier | Amount | Identifier | Notes |
| 00001 | Cardholder A | $100.00 | ABC | |
| | | | Sports | |
| 00002 | Cardholder B | (−$105.00) | 123 | |
| | | | Restaurant | |
| 00003 | Cardholder A | (−$75.00) | ABC | Related to |
| | | | Sports | Transaction |
| | | | | 00001 |

In Table 1, Transaction 00002 may be identified as a return transaction because a negative transaction amount is listed that constitutes a return indicator 614. Transaction 00003 may be identified as a return transaction because a negative transaction amount is listed and the transaction is related to Transaction 00001.

An explicit indicator may include, for example, a flag indicating that a transaction is a return transaction. In one example, set of first transaction data 610 may include a record for “Transaction Type” with a possible value of “Return”. Accordingly, when monitoring computer system 112 processes set of first transaction data 610 and identifies a value of “Return”, monitoring computer system 112 may accordingly identify the value as an explicit indicator that serves as return indicator 614. In another example, set of first transaction data 610 may include a record for “Return Transaction” with possible values of, “Y” and “N”. Similarly, when monitoring computer system 112 processes the set of first transaction data and identifies a value of “Y”, monitoring computer system 112 may accordingly identify the value as an explicit indicator that serves as return indicator 614.

Monitoring computer system retrieves return record 620 associated with cardholder 22. Return record 620 represents a record of return data associated with cardholder 22. In some examples, return record 620 includes return data associated with returns to merchant 24. Accordingly, in this example, return record 620 is specifically generated for each combination of merchant 24 and cardholder 22. In other examples, return record 620 includes return data associated with returns to all merchants in the same category as merchant 24. For example, if merchant 24 is a sporting goods store, return record 620 may include return data associated with cardholder for all sporting goods stores. Alternately, any categorization of merchants 24 may be applied to define return record 620. In additional examples, return record 620 includes return data associated with returns of similar products to the product returned by cardholder 22.

Return record 620 includes cardholder record identifier 622 that is used to compare set of first return transaction data 612 to return record 620. Monitoring computer system 112 retrieves return record 620 from memory 310 by identifying at least one cardholder identifier 616 associated with set of first return transaction data 612 and retrieving return record 620 associated with at least one cardholder identifier 616 by comparison to cardholder record identifier 622. Cardholder identifier 616 may be any identifier that can connect data stored in set of first transaction data 610 to the return record 620. Accordingly, cardholder identifier 616 may include, without limitation, an account number associated with cardholder 22, location information associated with cardholder 22, and a name associated with cardholder 22. The return record 620 is retrieved from at least one of memory device 310 associated with the monitoring computer system 112, a database in communication with monitoring computer system 112, networked storage in communication with monitoring computer system 112, or an external storage device in communication with monitoring computer system 112.

Return record 620 may additionally include historical record 624 including historical record of related returns. Historical record 624 of related returns may include set of second return transaction data 626 wherein set of second return transaction data 626 is substantially similar to set of first return transaction data 612. Set of second return transaction data 626 may be determined to be substantially similar to set of first return transaction data 612 based on a plurality of characteristics including, without limitation, products returned, categories associated with products returned, locations and times of product returns, time differences between initial purchase of products and returns of products, value of products, and brand of products. Set of second return transaction data 626 may be collected from a plurality of payment systems 118 associated with plurality of merchants 24. Accordingly, set of second return transaction data 626 may include records of related returns that are substantially similar in nature to the returns included in set of first return transaction data 612 but associated with different merchants 24. In such examples, set of second return transaction data 626 may be determined to be substantially similar to set of first return transaction data 612 based on additional characteristics including, without limitation, the location of merchants 24, and the categories of merchants 24. When return record 620 is retrieved, historical return record 624 and second return transaction data 626 are also retrieved.

Monitoring computer system 112 also determines if retrieved return record 620 includes at least one set of second return transaction data 626 associated with at least one second return transaction and transmits return record 620 to a payment system 118 such as merchant computing device 26. In other words, monitoring computer system 112 determines whether return record 620 indicates that cardholder 22 has a previous record of a similar return and, if so determined, transmits return record 620 to payment system 118. Receiving return record 620 may be valuable to merchant 24 receiving over payment system 118 because return record 620 may provide information about cardholder 22 that may be of value to merchant 24. For example, a long history of returns in return record 620 may indicate that the instant return should be further scrutinized due to risk of damaged goods, fraud, or other conditions of concern to merchant 24. Return record 620 may be transmitted using any communication method including, without limitation, email, SMS, network transfer, and web service.

Monitoring computer system 112 further processes at least one set of second return transaction data 626 to generate cardholder risk assessment 630 and transmits cardholder risk assessment 630 to payment system 118. Cardholder risk assessment 630 represents a risk determination associated with the instant transaction made by cardholder 22 in returning goods to merchant 24. Cardholder risk assessment 630 may represent a risk of fraud, damaged goods, improper returns, or any other type of risk relevant to set of first return transaction data 612. Cardholder risk assessment 630 may include a numerical score, a qualitative rating, or any other indication that merchant 24 may review to assess risks related to the return activity of the cardholder. Merchant 24 may utilize return record 620 and cardholder risk assessment 630 to make a determination on whether to accept the instant return from cardholder 22 or to scrutinize it further.

Monitoring computer system 112 further updates return record 620 associated with cardholder 22 with set of first return transaction data 612. Accordingly, return record 620 is updated to include return data associated with the cardholder-initiated return transaction. More specifically, monitoring computer system 112 builds return record 620 over time by updating with set of first return transaction data 612 in historical record 624 associated with cardholder record identifier 622. Set of first return transaction data 612 is stored in return record 620 as particular set of second return transaction data 626.

Monitoring computer system 112 additionally receives a request for a return dashboard 640 associated with a time period. The request for return dashboard 640 is received from payment system 118 associated with merchant 24. Monitoring computing system 112 retrieves return records 620 associated with all cardholders 22 associated with merchant 24. Monitoring computing system 112 identifies return records 620 associated with the time period from all return records 620 and generates return dashboard 640 associated with the time period based on return records 620 associated with the time period. Monitoring computer system 112 transmits return dashboard 640 to payment system 118. Return dashboard 640 accordingly represents a report on all return records 620 for cardholders 22 associated with requesting merchant 24 over the requested time period.

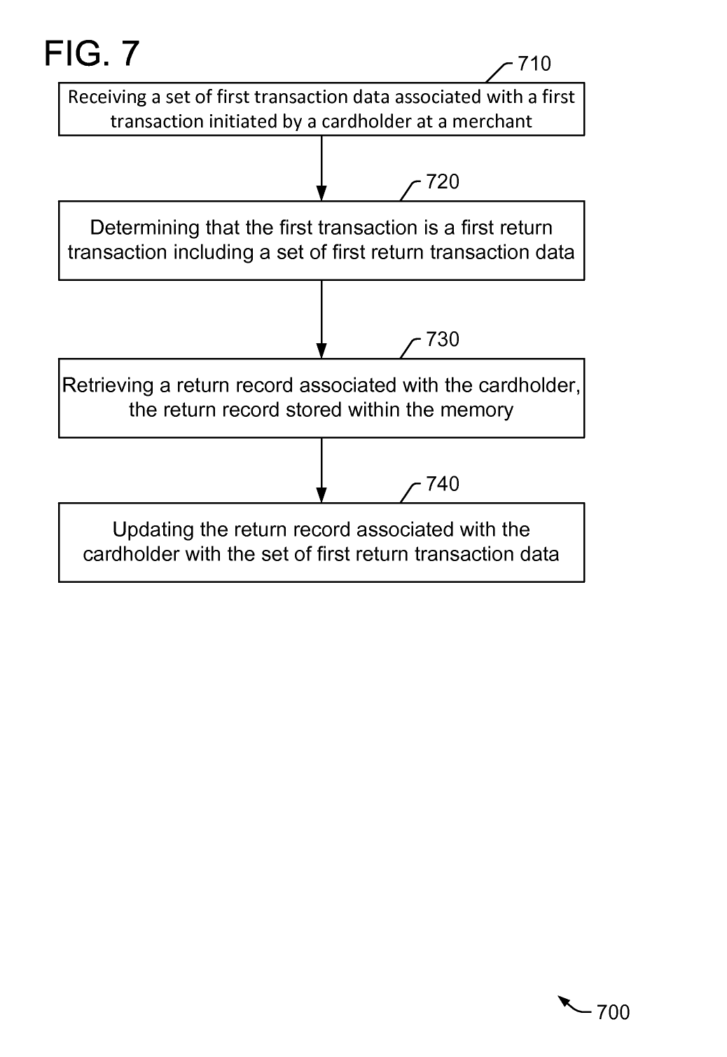

FIG. 7 is a simplified diagram of an example method 700 of monitoring cardholder return activity associated with cardholder transactions using monitoring computer system 112 (shown in FIG. 2). Monitoring computer system 112 receives 710 a set of first transaction data associated with a first transaction initiated by a cardholder at a merchant. Receiving represents monitoring computer system 112 receiving set of first transaction data 610 (shown in FIG. 6).

Monitoring computer system 112 also determines 720 that first transaction is a first return transaction including a set of first return transaction data. Determining 720 represents monitoring computer system 112 determining that set of first return transaction data 612 includes return indicator 614 (shown in FIG. 6).

Monitoring computer system 112 additionally retrieves 730 a return record associated with the cardholder, the return record stored within the memory. Retrieving 730 represents retrieving return record 620 (shown in FIG. 6) from memory 310 (shown in FIG. 3). Return record 620 may additionally include historical record 624 (shown in FIG. 6). In at least some examples, return record 620 is retrieved based upon comparison between cardholder record identifier 622 (shown in FIG. 6) and cardholder identifier 616 (shown in FIG. 6).

Monitoring computer system 112 also updates 740 return record associated with the cardholder with the set of first return transaction data. Updating 740 represents storing set of first return transaction data 612 with return record 620 associated with cardholder 22 (shown in FIG. 1)

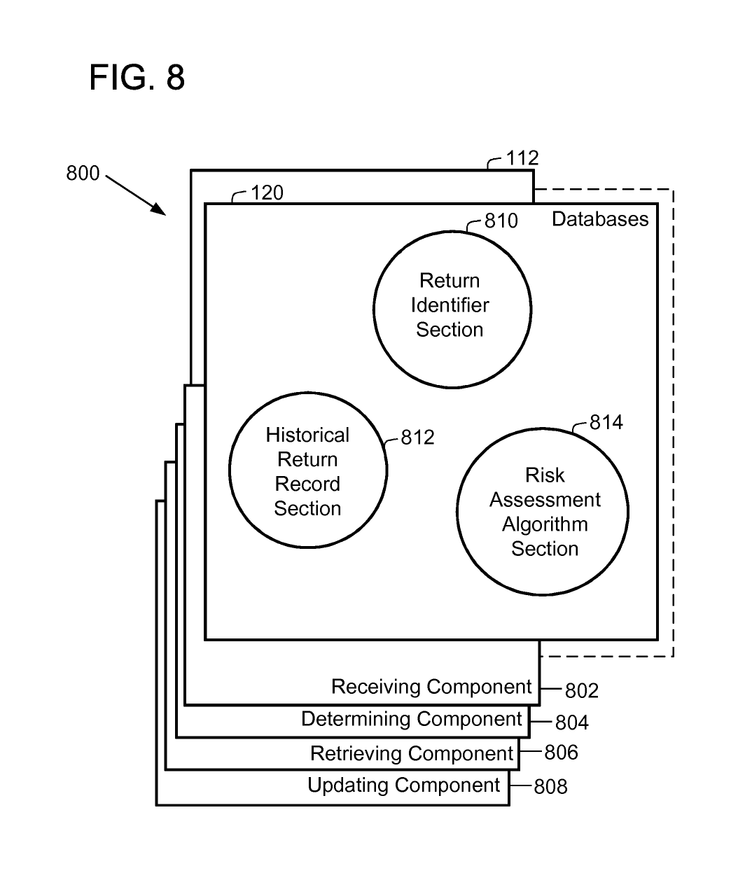

FIG. 8 is a diagram 800 of components of one or more example computing devices that may be used in the environment shown in FIG. 6. FIG. 8 further shows a configuration of databases including at least database 120 (shown in FIG. 1). Database 120 is coupled to several separate components within computer system 112, which perform specific tasks.

Computer system 112 includes a receiving component 802 for receiving a set of first transaction data 610 (shown in FIG. 6). Computer system 112 also includes a determining component 804 for determining that a first transaction is a first return transaction including set of first return transaction data 612 (shown in FIG. 6). Computer system 112 additionally includes a retrieving component 806 for retrieving return record 620 (shown in FIG. 6). Computer system 112 additionally includes an updating component 808 for updating return record 620 with set of first return transaction data 612.

In an exemplary embodiment, database 120 is divided into a plurality of sections, including but not limited to, a return identifier section 810, a historical return record section 812, and a risk assessment algorithm section 814. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for monitoring cardholder return activity associated with cardholder transactions, the method implemented by a monitoring computer system in communication with a memory, the method comprising:
receiving, at the monitoring computer system, a set of first transaction data associated with a first transaction initiated by a cardholder at a merchant;
determining that the first transaction is a first return transaction including a set of first return transaction data;
retrieving a return record associated with the cardholder, the return record stored within the memory; and
updating the return record associated with the cardholder with the set of first return transaction data.

2. The method of claim 1, further comprising:
upon determining that the return record includes at least one set of second return transaction data associated with at least one second return transaction, transmitting the return record to a merchant computing device.

3. The method of claim 2, further comprising:
processing the at least one set of second return transaction data to generate a cardholder risk assessment; and
transmitting the cardholder risk assessment to the merchant computing device.

4. The method of claim 1, wherein determining that the first transaction is a first return transaction further comprises:
processing the set of first transaction data to identify the presence of a return indicator.

5. The method of claim 1, wherein retrieving a return record associated with the cardholder further comprises:
identifying at least one cardholder identifier associated with the set of first return transaction data; and
retrieving a return record associated with the at least one cardholder identifier from at least one of the memory, a database in communication with the monitoring computer system, and an external system in communication with the monitoring computer system.

6. The method of claim 1, wherein retrieving a return record associated with the cardholder further comprises:
retrieving a return record associated with the cardholder wherein the return record includes a historical record of related returns, the historical record of related returns including a set of second return transaction data substantially similar to the set of first return transaction data.

7. The method of claim 6, wherein retrieving the return record further comprises:
retrieving the set of second return transaction data collected from a plurality of merchant computing devices associated with a plurality of merchants.

8. The method of claim 1, wherein the monitoring computer system is in communication with a payment network, further comprising:
receiving the set of first transaction data at the monitoring computer system from the payment network.

9. The method of claim 1, further comprising:
receiving, from a merchant computing device, a request for a return dashboard associated with a time period;
retrieving all return records associated with all cardholders associated with the merchant;
identifying, from all return records, return records associated with the time period;
generating, based on return records associated with the time period, the return dashboard associated with the time period; and
transmitting the return dashboard to the merchant computing device.

10. A monitoring computer system for monitoring cardholder return activity associated with cardholder transactions comprising:
a processor;
a memory coupled to said processor, said processor configured to:
receive a set of first transaction data associated with a first transaction initiated by a cardholder at a merchant;
determine that the first transaction is a first return transaction including a set of first return transaction data;
retrieve a return record associated with the cardholder;
update the return record associated with the cardholder with the set of first return transaction data.

11. A monitoring computer system in accordance with claim 10 wherein the processor is further configured to:
transmit the return record to a merchant computing device upon determining that the return record includes at least one set of second return transaction data associated with at least one second return transaction.

12. A monitoring computer system in accordance with claim 11 further configured to:
process the at least one set of second return transaction data to generate a cardholder risk assessment; and
transmit the cardholder risk assessment to the merchant computing device.

13. A monitoring computer system in accordance with claim 10 further configured to:
process the set of first transaction data to identify the presence of a return indicator.

14. A monitoring computer system in accordance with claim 10 further configured to:
identify at least one cardholder identifier associated with the set of first return transaction data; and
retrieve a return record associated with the at least one cardholder identifier from at least one of the memory, a database in communication with the monitoring computer system, and an external system in communication with the monitoring computer system.

15. A monitoring computer system in accordance with claim 10, further configured to:
retrieve a return record associated with the cardholder wherein the return record includes a historical record of related returns, the historical record of related returns including a set of second return transaction data substantially similar to the set of first return transaction data.

16. A monitoring computer system in accordance with claim 15, further configured to:
retrieve the set of second return transaction data collected from a plurality of merchant computing devices associated with a plurality of merchants.

17. A monitoring computer system in accordance with claim 10, wherein the monitoring computer system is in communication with a payment network, further configured to:
receive the set of first transaction data from the payment network.

18. A monitoring computer system in accordance with claim 10, further configured to:
receive, from a merchant computing device, a request for a return dashboard associated with a time period;
retrieve all return records associated with all cardholders associated with the merchant;
identify, from all return records, return records associated with the time period;
generate, based on return records associated with the time period, the return dashboard associated with the time period; and
transmit the return dashboard to the merchant computing device.

19. Computer-readable storage media for monitoring cardholder return activity associated with cardholder transactions having computer-executable instructions embodied thereon, wherein, when executed by at least one processor, the computer-executable instructions cause the processor to:
receive a set of first transaction data associated with a first transaction initiated by a cardholder at a merchant;
determine that the first transaction is a first return transaction including a set of first return transaction data;
retrieve a return record associated with the cardholder;
update the return record associated with the cardholder with the set of first return transaction data.

20. The computer-readable storage media in accordance with claim 19, wherein the computer-executable instructions cause the processor to:
transmit the return record to a merchant computing device upon determining that the return record includes at least one set of second return transaction data associated with at least one second return transaction.
